(19) United States
(12) Patent Application Publication
(10) Pub. No.: US 2015/0118915 A1
(43) Pub. Date: Apr. 30, 2015

(54) ASSEMBLY FOR A PREFABRICATED TERMINAL BLOCK AND METHOD FOR PRODUCING PREFABRICATED TERMINAL BLOCKS

(71) Applicant: Robert Bosch GmbH, Stuttgart (DE)

(72) Inventor: Gerald Friess, Grossbottwar (DE)

(21) Appl. No.: 14/400,342

(22) PCT Filed: Apr. 24, 2013
(86) PCT No.: PCT/EP2013/058472

§ 371 Date: Nov. 11, 2014

(30) Foreign Application Priority Data
May 11, 2012 (DE) 10 2012 207 877.0

(51) Int. Cl. H01R 9/24; B60R 16/023; H01R 9/22; H01R 43/18

(52) U.S. Cl. CPC H01R 9/24; H01R 43/18; B60R 16/023; H01R 9/223
USPC 439/736; 264/272.14

(57) ABSTRACT

The invention relates to an assembly for a prefabricated terminal block and to a method for producing a prefabricated terminal block, wherein two pre-moulded parts are held together by an injection-moulded base frame. The pre-moulded parts can be designed to provide electrical contacts for contacting an engine control unit for example, in order to establish electrical connections to the engine control unit. In particular, prefabricated parts for terminal blocks that are flexible with respect to material and colouring can be implemented in this way.

### BACKGROUND OF THE INVENTION

The manufacture of terminal blocks, in particular for use in the automotive field, by means of plastic injection molding technology is known in the prior art. Injection molds in the prior art are, however, either totally inflexible with respect to short-term dimensional changes or else are extremely expensive because said molds consist of many parts and many different modules have to be made available in order to be able to form sections of a desired mold of an injection molded part. Components which have to be flexibly adapted with respect to shape and coloring are often individually manufactured and are later joined to one another by means of snap-on/detent connections or else in a materially bonded manner by known welding or adhesive bonding techniques. Whereas snap-on/detent connections have tolerances that are too high or strengths that are too low for many areas of application, welding methods for joining plastic parts to be joined to one another are complex and expensive. Multi-component injection molding methods do in fact allow for different color schemes of segments of an injection molded part that are spatially remote from one another. Said methods are, however, too expensive and inflexible for many applications. A subsequent coloring of constituent parts of a plastic component is in fact very flexible, has however the disadvantage that manual work is sometimes necessary or only relatively complex equipment can produce a satisfactory result. When applying paints and varnishes, it is furthermore not always ensured that the optical identification can withstand the sometimes tough operating conditions over time.

It is therefore the aim of the present invention to enable the flexible production of properly dimensioned terminal blocks and to quickly adapt the method of manufacture in an uncomplicated manner to customer requirements.

It is a further aim of the present invention to manufacture multi-colored plastic components with minimal effort, minimum costs and cost effectively without the stability problems which result in the prior art.

### SUMMARY OF THE INVENTION

The aims mentioned above are met according to the invention by means of a method for producing prefabricated terminal blocks, an assembly for a prefabricated terminal block, an engine control unit and a method for producing an engine control unit.

The method according to the invention for producing prefabricated terminal blocks thereby comprises the step: inserting at least two pre-molded parts into a common injection mold. According to one possible perspective, the pre-molded parts thereby already constitute in each case one terminal block for respectively one electrical connection, e.g. by means of two electrical contacts in a connector housing. Within the scope of the present invention, a “prefabricated terminal block” is to be understood as a component comprising a collection of electrical contact devices, wherein the component can comprise prefabricated elements and, e.g., prefabricated elements which are specially arranged and/or designed to meet the request of the customer, such as, e.g., pre-molded parts. Said prefabricated elements are held together in the terminal block produced according to the invention in such a way that, despite a certain mechanical flexibility of the component, an integral composite referred to as a block can still be said to be present.

Examples of measures for prefabricating the terminal block are predetermined color schemes of individual electrical contact devices (pre-molded parts) by means of coloring the respective plastic materials of the plastic constituent parts of the block or otherwise a customer specific geometrical design of individual contact devices with respect to other contact devices. Rough dimensions of the individual contact devices can preferably be determined here, within the scope of which contact devices produced or delivered according to the request of the customer can be integrated into a composite. In addition, the metallic contacts in the pre-molded parts can also have different surfaces and/or coatings, such as, e.g., consisting of tin, silver, gold or a coating comprising such materials in order to meet the corresponding demands. The term “common injection mold” is to be understood within the scope of the present invention as a tool which holds the pre-molded parts together as contact devices in such a way that all of the pre-molded parts can at least be held together in sections in a common injection molding volume for joining in an injection molding process. The pre-molded parts can thereby either already comprise electrical contacts or alternatively or additionally be provided with electrical contacts in a subsequent procedural step. As a further step, the method according to the invention comprises a joining of the pre-molded parts in which said pre-molded parts are held together or enclosed in a base frame using an injection molding process. To this end, the pre-molded parts can, for example, be inserted into an opening in the outer wall of the injection mold, so that only the back side of said parts, which now seals the injection molding volume of the injection mold towards the outside, is wetted or covered by the injection molding material. The base frame (for example of an engine control unit) is formed by this process, which defines the spatial orientation of the pre-molded parts within the terminal block to be produced.

The method can further advantageously comprise a step in which electrical contacts are introduced into the pre-molded parts after the base frame has been constructed by the previously described injection molding process and a wall of the injection mold that is opposite the pre-molded parts has been removed. In this way, the electrical contacts can, for example, be inserted or “stitched into” the pre-molded parts from the backside, i.e. from the direction of the base frame, or from the front side, i.e. in the connection direction. The base frame which is not yet completely or is completely cured can also thereby be pierced by the electrical contacts. The aforementioned production step has the inherent advantage that the electrical contacts are not damaged or unintentionally wetted with injection molding material; however the aforementioned process can, of course, only take place after the demolding process. Pre-molded parts can alternatively or additionally be used which comprise electrical contacts already prior to the injection molding process, which can, for example, take place in a process known as “hot stitching” within the scope of the production of the pre-molded parts. In this connection, it is advantageous if the electrical contacts extend on both sides through the injection volumes of the injection mold. In other words, neither the ends of the electrical contacts within the pre-molded parts nor the opposite ends come in contact with the injection molding material. This has the advantage that a procedural step is eliminated within the scope of the production of the terminal block and/or special tools for producing non-insertable contacts may in fact be required for producing the pre-molded parts themselves but not for the inventive production of the terminal blocks.

It is furthermore advantageous for the method according to the invention to comprise the step of sealing the side of the pre-molded part facing the base frame. In so doing, a sealing agent is applied to the surface of the pre-molded parts in that region through which, for example, the electrical contacts have been inserted. The agent can thereby be any suitable sealing agent which is suited to the subsequent sealing of such a construction, such as, for example, an adhesive, a resin or a gel. Provided a gel is used, the sealing process mentioned above can also be referred to as a “gel injection”. This has the advantage that a sealing impermeable to fluids can be implemented between the front side of the terminal block to be produced and the back side thereof. A circumferential seal, for example consisting of a polymer, a synthetic resin, an adhesive or similar suitable materials can alternatively or additionally be provided on a side of the base frame facing the pre-molded parts. This has the advantage that, after inserting the terminal block into an area, e.g. an inner wall of a control unit housing, which is at least in part penetrated by the pre-molded parts, ingressing fluid and other external influences are stopped between said area and said pre-molded parts.

A further aspect of the present invention relates to how an assembly for a prefabricated terminal block can be produced in combination with the method described above. The assemblies according to the invention can be obtained as a procedural outcome of the previously described methods according to the invention, which is why reference can analogously be made to what has been stated above for a detailed discussion of the design of said assemblies as well as the advantages thereof.

According to the invention, pre-molded parts can have so-called “homogenizing ribs” for connecting to the base frame. By the term “homogenizing ribs”, structures which have a small cross section and protrude from a surface of the pre-molded parts are to be understood in connection with the present invention, wherein the cross section is dimensioned such that a heating of the structures which is induced by surrounding injection molding material results in a partial melting or fusing of the structures and thereby in a permanent and stable connection to the injection molding material. To this end, the homogenizing ribs are provided on the pre-molded parts in that region which is disposed within the basic injection mold or, respectively, within the injection molding volume. In this way, a material bond is on the one hand enabled between the pre-molded parts and the base frame; however, depending on the arrangement of the homogenizing ribs on the surface of the pre-molded parts, a form fit of said pre-molded parts in the base frame also occurs. In this way, a particularly stable and durable connection results between the pre-molded parts and the base frame.

Depending on the customer's wishes and/or statutory requirements, the electrical contact devices or, respectively, the pre-molded parts of the inventive assembly can comprise different material and very preferably, but nevertheless additionally or alternatively, be colored differently. Thus, an optical discriminability is alternatively or additionally ensured as well as a tactile discriminability of the electrical contact devices for the component service life.

A further aspect of the present invention relates to an engine control unit comprising a terminal block, wherein the terminal block can comprise an assembly that is configured as stated above and/or can have been produced in a manufacturing process as described above. The use of an inventive terminal block in an engine control unit has the advantage that through-colored plastic parts or the color scheme thereof can only be affected by large changes in temperature and the effects of weather and chemicals to a limited extent; thus preventing the electrical contacts in the pre-molded parts from being falsely contacted.

A further aspect of the present invention relates to a method for producing an engine control unit which comprises the steps of one of the manufacturing methods described above. In other words, a prefabricated terminal block is initially produced which is subsequently installed in an engine control unit. In particular for passenger cars, e.g., comprising internal combustion engines, the invention provides a suitable method for producing a terminal block and furthermore makes the terminal block available as a component which can withstand demanding operating conditions and provide a long service life.

### BRIEF DESCRIPTION OF THE DRAWINGS

Exemplary embodiments of the invention are described below in detail with reference to the accompanying drawings. In the drawings:

FIG. 1 shows a cross-sectional view of an exemplary embodiment of a terminal block according to the invention in a housing;

FIG. 2 shows a detailed view of a material boundary between the pre-molded part 10 and the base frame 40;

FIG. 3 shows a cross-sectional view through an injection mold fitted with pre-molded parts, as said mold could be used in an exemplary embodiment of the method according to the invention; and

FIG. 4 shows a cross-sectional view through an assembly for a prefabricated terminal block, after a part of the injection mold has been removed and the electrical contacts have been introduced.

### DETAILED DESCRIPTION

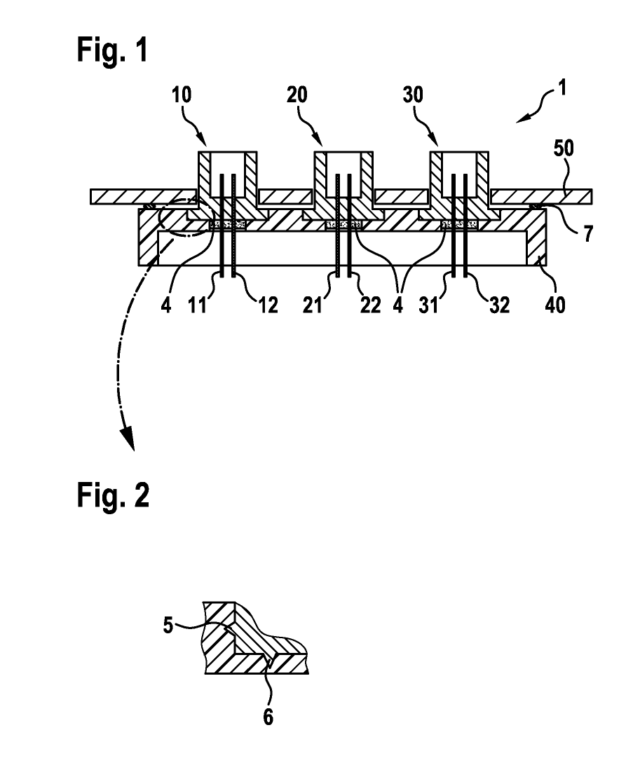

FIG. 1 shows a cross-sectional view through an exemplary embodiment of a prefabricated terminal block 1 according to the invention. The terminal block 1 comprises three pre-molded parts 10, 20, 30, which penetrate openings in a housing 50 of an engine control unit (ECU). The pre-molded parts 10, 20, 30 are held together on the back sides thereof by a base frame 40. Electrical contacts 11, 12, 21, 22, 31 and 32 penetrate in each case in pairs (e.g. in single or multiple rows) the pre-molded parts 10, 20, 30 as well as a gel injection which is provided at the back in the region of the electrical contacts 11, 12, 21, 22, 31 and 32 and is disposed in a region of the base frame 40 without injection molding material. A seal 7 extending circumferentially around the pre-molded parts 10, 20, 30 is provided between the housing 50 of the engine control unit and the front of the base frame 40, said seal being applied under preload between the housing 50 and the base frame 40. The pre-molded parts 10, 20, 30 comprise a hollow body section, e.g. in a bathtub shape, in the upper portion thereof and close in the closed base region thereof with a circumferential flange that protrudes with respect to the hollow body section.

FIG. 2 shows a material boundary between the pre-molded part 10 and the base frame 40 in a cut-out depiction, in which homogenizing ribs 5, 6 can be seen protruding from the surface of the pre-molded part 10. During the injection molding process, the substantially triangular cross section of the homogenizing ribs achieves a temperature profile within the homogenizing rib 5, 6 which has higher temperatures towards the tip of said homogenizing ribs. The homogenizing rib 5, 6 therefore tends to partially melt during the injection molding process particularly in the region of said tip, and the material of the pre-molded part 10 is connected to the base frame 40 in a materially bonded manner in this region.

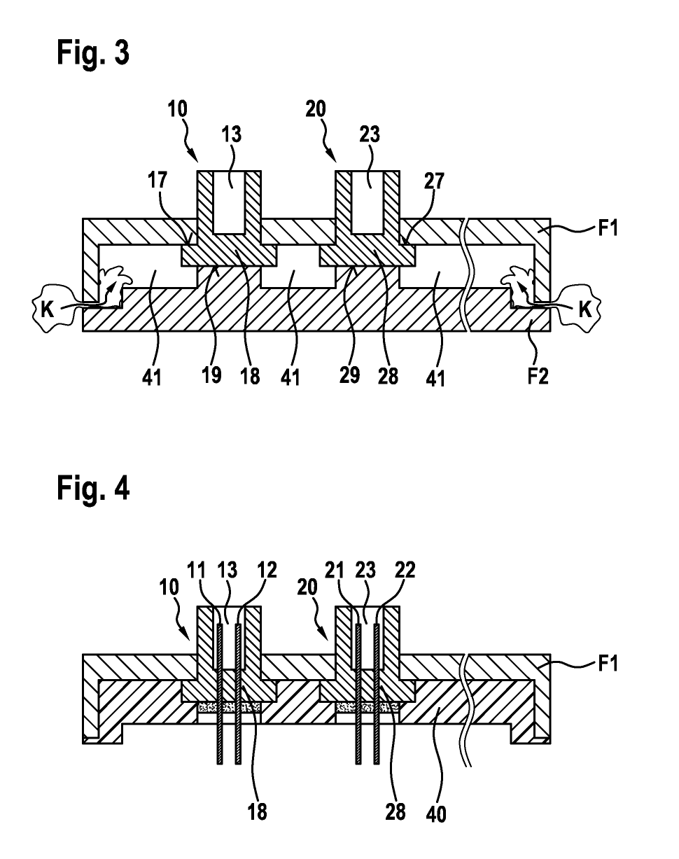

FIG. 3 shows a cross-sectional view through the pre-molded parts 10, 20 which are inserted into a plastic injection mold F1, F2. Hollow spaces 13, 23 in the front region of the pre-molded parts 10, 20 are designed to receive electrical contacts 11, 12, 21, 22 (which are depicted in FIG. 4). On the front side, the flange 17, 27 of the pre-molded parts 10, 20 abuts against the inner side of the front plastic injection mold Fl in the region of two openings. In this way, the pre-molded parts 10, 20 close the openings in the otherwise nearly closed injection molding volume 41 of the injection mold F1, F2. On the back side, a second part F2 of the injection mold F1, F2 abuts against a central region 19, 29 of the back wall of the pre-molded parts 10, 20. In this way, the second part of the injection mold F2 protects the bases 18, 28 of the pre-molded parts 10, 20 from coming in contact with the injection molding material in the central region 19, 29. An introduction of plastic material K in a liquid form into the injection molding volume 41 is indicated on both sides.

FIG. 4 shows the arrangement depicted in FIG. 3 after the second part F2 of the injection mold has been removed. Electrical contacts 11, 12, 21, 22 are inserted through the base 18, 28 into the hollow spaces 13, 23 of the pre-molded parts 10, 20 and are available for electrical contacting. The depicted arrangement can subsequently (not depicted) be turned over and the rear region 19, 29 can be sealed around the electrical contacts 11, 12, 21, 22 by a small amount of gel under the effect of gravity. The front part F1 of the injection mold F1, F2 can be used for handling and stabilizing the manufactured assembly during the introduction of the electrical contacts as well as during the gel injection at the back sides 19, 29.

It is a central idea of the present invention to provide pre-molded parts that are especially made from plastic as electrical contacting devices in a connector strip by said pre-molded parts being disposed at least partially in an injection molding volume of a common injection mold and being connected to one another by means of an injection molding process. An integral component is manufactured in this procedural step which can meet high strength requirements without requiring expensive joining processes or a complicated coordination of tolerances as is the case with individual installation or individual connectors of a snap-on/detent connection. In this way, the number of parts at the manufacturing plant (e.g. a factory building of the automotive supplier industry) can be reduced and a simpler BOM structure requiring less disposition effort and technical support can be implemented. In so doing, the terminal block can be mechanically more rigidly designed and can be optimized with regard to the service life thereof. In addition, the manufacturing time in assembling an engine control unit (ECU) and the costs and complexity of tools to be kept on hand can be reduced. The present invention furthermore offers a high degree of design freedom with regard to the color coding of individual terminals of a terminal block.

Even if the inventive aspects and advantageous embodiments have been described in detail with the aid of the exemplary embodiments which have been explained in combination with the attached drawings, modifications to and combinations of the features in the depicted exemplary embodiments are possible for the person skilled in the art without departing from the scope of the present invention, the scope of protection of which is defined by the attached claims.

1. A method for producing prefabricated terminal blocks (1), comprising the steps:
disposing at least two pre-molded parts (10, 20), which each are equipped to comprise electrical contacts (11, 12; 21, 22), in a common injection mold (F1, F2), and
connecting the pre-molded parts (10, 20) by said pre-molded parts (10, 20) being held together in a base frame (40) by means of an injection molding process.

2. The method according to claim 1, further comprising the step:
introducing electrical contacts (11, 12; 21, 22) into the pre-molded parts (10, 20).

3. The method according to claim 1, further comprising the step:
sealing a side (19, 29) of the pre-molded parts (10, 20) that faces the base frame (40) by means of a gel injection (4).

4. An assembly for a prefabricated terminal block (1) comprising:
at least two pre-molded parts (10, 20) which are each equipped to comprise electrical contacts (11, 12; 21, 22), wherein the pre-molded parts (10, 20) are injected into a common base frame (40) made from plastic material (K).

5. The assembly according to claim 4 further comprising electrical contacts (11, 12; 21, 22) in the pre-molded parts (10, 20) which are inserted or “stitched into” said pre-molded parts (10, 20) and/or into the base frame (40) after the injection molding process and/or have already been inserted during the manufacture of said pre-molded parts (10, 20).

6. The assembly according to claim 4 further comprising:
a seal on the side of the pre-molded parts (10, 20) that faces the base frame (40).

7. The method according to claim 1, wherein the pre-molded parts comprise homogenizing ribs (5, 6) for connecting to the base frame (40).

8. The method according to claim 1, wherein the prefabricated terminal block (1) has two separate electrical connecting devices in the form of differently colored pre-molded parts (10, 20).

9. An engine control unit (ECU) comprising a terminal block (1) according to claim 4.

10. A method for manufacturing an engine control unit (ECU) comprising the steps of a method according to claim 1.

11. The method according to claim 1, further comprising the step:
introducing electrical contacts (11, 12; 21, 22) into the pre-molded parts (10, 20) by the electrical contacts (11, 12; 21, 22) being inserted or “stitched into” said pre-molded parts.

12. The method according to claim 1, further comprising the step:
using pre-molded parts (10, 20) which already comprise electrical contacts (11, 12; 21, 22) prior to the injection molding process, said contacts penetrating an injection molding volume (41) of the injection mold (F1, F2).

13. The method according to claim 1, further comprising the step:
using pre-molded parts (10, 20) which already comprise electrical contacts (11, 12; 21, 22) prior to the injection molding process.

14. The method according to claim 3, further comprising the step:
providing a circumferential seal (7) on a side of the base frame (40) that faces the pre-molded parts.

15. The method according to claim 1, further comprising the steps:
sealing the side (19, 29) of the pre-molded parts (10, 20) that faces the base frame (40) by means of a gel injection (4); and
providing a circumferential seal (7) on a side of the base frame (40) that faces the pre-molded parts.

16. The assembly according to claim 4 further comprising:
a seal on the side of the pre-molded parts (10, 20) that faces the base frame (40), the seal being in the form of a gel injection (4).

17. The assembly according to claim 4 further comprising:
a circumferential seal (7) on a side of the base frame (40) that faces the pre-molded parts.

18. The assembly according to claim 17 further comprising:
a seal on the side of the pre-molded parts (10, 20) that faces the base frame (40).

19. The device according to claim 4, wherein the pre-molded parts comprise homogenizing ribs (5, 6) for connecting to the base frame (40).

20. The device according to claim 4, wherein the prefabricated terminal block (1) has two separate electrical connecting devices in the form of differently colored pre-molded parts (10, 20).
